(19) United States
(12) Patent Application Publication
(10) Pub. No.: US 2012/0140615 A1
(43) Pub. Date: Jun. 7, 2012

(54) METHOD, STATION AND COMPUTER READABLE MEDIUM FOR DOWNLINK MULTI-USER MULTIPLE ACCESS CATEGORY MEDIUM ACCESS AND ERROR RECOVERY

(76) Inventor: Michelle X. Gong, Sunnyvale, CA (US)

(21) Appl. No.: 12/959,742

(22) Filed: Dec. 3, 2010

(51) Int. Cl. H04L 12/26

(52) U.S. Cl. 370/216

(57) ABSTRACT

A method, device and computer readable medium for downlink multi-user multiple input multiple output (MU MIMO) multiple access category (AC) medium access and error recovery. The method includes transmitting a plurality of aggregated MAC protocol data units (A-MDPUs) from the transmitting STA to respective ones a plurality of receiving STAs, the A-MDPUs being associated with respective access categories (ACs) and defining a primary AC. The method further includes doubling a contention window (CW) of at least one of the primary AC and a failed AC if an A-MPDU transmission failure occurs.

### TECHNICAL FIELD

The present disclosure relates generally to the field of wireless communications and more particularly to systems and related methods for improving network capacity in a wireless environment.

### BACKGROUND

Wireless local area networks (WLAN)s using communication protocols such as the IEEE 802.11 set of standards provide over the air modulation techniques for the transfer of data using wireless signals. Standards within the 802.11 set of standards, such as IEEE 802.11n, provide features to allow communication using multiple input multiple output (MIMO) techniques. To reduce latency between communications among several receiving STAs, some multi-carrier communication stations may be configured to send communications to several receiving STAs concurrently in time and frequency. Within the 802.11 environment, there exists a need for a method to achieve very high throughput in a basic service set (BSS) to increase network capacity through use of downlink (DL) multi-user (MU) MIMO techniques.

### BRIEF DESCRIPTION OF THE DRAWINGS

The subject matter regarded as embodiments is particularly pointed out and distinctly claimed in the concluding portion of the specification. Embodiments, however, both as to organization and method of operation, together with objects, features, and advantages thereof, may best be understood by reference to the following detailed description when read with the accompanying drawings in which:

FIG. 1 is a block diagram illustrating a wireless communication network in accordance with embodiments;

FIG. 2 is a block diagram of an DL MU MIMO operation in accordance with some embodiments;

FIG. 3 is a block diagram of a transmission opportunity (TXOP) operation of DL MU MIMO in accordance with some embodiments;

FIG. 4 is a block diagram of error recovery in a TXOP in accordance with some embodiments;

FIG. 5 is a flow diagram of DL MU MIMO communication in accordance with some embodiments.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

In the following detailed description, numerous specific details for improving communications in a wireless communication network through fair medium sharing and for enabling error recovery in the network are set forth to provide a thorough understanding of embodiments. However, it will be understood by those skilled in the art that the invention may be practiced without these specific details. In other instances, well-known methods, procedures, components and circuits have not been described in detail so as not to obscure embodiments.

One approach to increasing network capacity of a basic service set (BSS) of a wireless communication network is to enable polled transmission opportunity (TXOP) support and effective medium transmissions by downlink (DL) multi-user (MU) MIMO capable AP's with multiple access categories (ACs), such as by providing error recovery for DL MU MIMO communications.

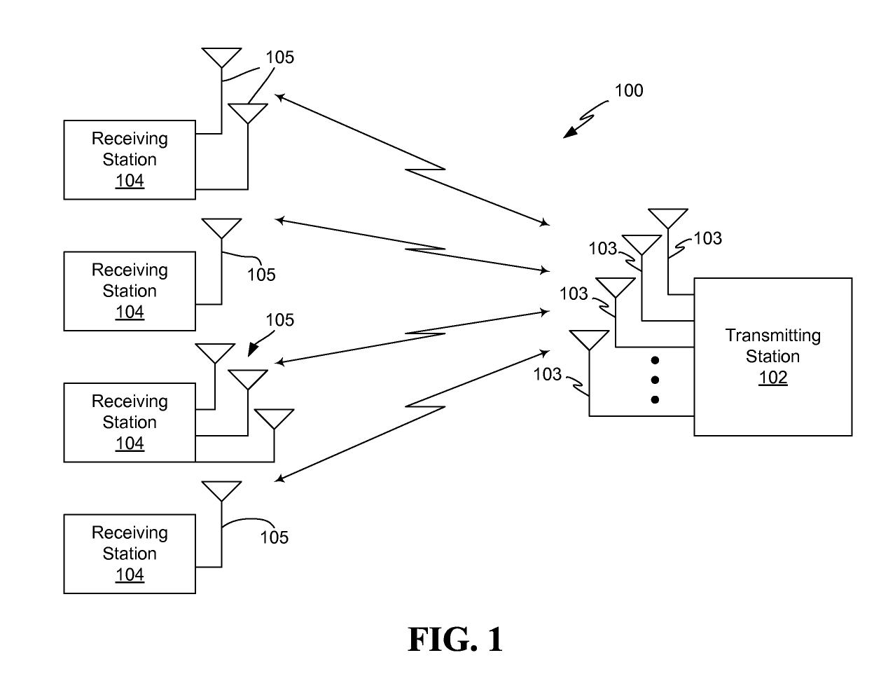

Now turning to the figures, FIG. 1 illustrates a block diagram of STAs or platforms in a network, such as a wireless network 100. Some embodiments may be embodied through a wireless communication station, a mobile station, an advanced station, a client, a platform, a wireless communication device, a wireless AP, a modem, a wireless modem, a Personal Computer (PC), a desktop computer, a mobile computer, a laptop computer, a notebook computer, a tablet computer, a server computer, a set-top box, a handheld computer, a handheld device, a Personal Digital Assistant (PDA) device, a handheld PDA device, and/or a netbook.

Alternately or in combination, the STAs or platforms can also use signals to communicate in the wireless network 100 such as a Local Area Network (LAN), a Wireless LAN (WLAN), a Metropolitan Area Network (MAN), a Wireless MAN (WMAN), a Wide Area Network (WAN), a Wireless WAN (WWAN), devices and/or networks operating in accordance with existing Next Generation mmWave (NGmS-D02/r0, Nov. 28, 2008), Wireless Gigabit Alliance (WGA), IEEE 802.11, 802.11a, 802.11b, 802.11e, 802.11g, 802.11h, 802.11i, 802.11n, 802.11ac, 802.16, 802.16d, 802.16e standards and/or future versions and/or derivatives and/or Long Term Evolution (LTE) of the above standards, a Personal Area Network (PAN), a Wireless PAN (WPAN), units and/or devices which are part of the above WLAN and/or PAN and/or WPAN networks, one way and/or two-way radio communication systems, cellular radio-telephone communication systems, a cellular telephone, a wireless telephone, a Personal Communication Systems (PCS) device, a PDA device which incorporates a wireless communication device, a Multiple Input Multiple Output (MIMO) transceiver or device, a Single Input Multiple Output (SIMO) transceiver or device, a Multiple Input Single Output (M ISO) transceiver or device, a Maximum Ratio Combining (MRC) transceiver or device, a transceiver or device having “smart antenna” technology or multiple antenna technology, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), OFDMA, Time-Division Multiplexing (TDM), Time-Division Multiple Access (TDMA), Extended TDMA (E-TDMA), General Packet Radio Service (GPRS), Extended GPRS, Code-Division Multiple Access (CDMA), Wideband CDMA (WCDMA), CDMA 2000, Multi-Carrier Modulation (MDM), Discrete Multi-Tone (DMT), Bluetooth (RTM), ZigBee™, or the like. Embodiments may be used in various other apparatuses, devices, systems and/or networks.

In one embodiment, STAs or platforms in the wireless network 100 may operate in accordance with one or more of the IEEE 802.11 standards and/or protocol under development by associated task groups such as 802.11ac. A STA operating in accordance with these protocols and/or standards may require the implementation of at least two layers. One layer is the 802.11 MAC layer (i.e., OSI Data/Link Layer 2). Another layer is the 802.11 PHY layer (i.e., OSI Physical Layer 1). The MAC layer may be implemented using either or a combination of dedicated hardware and dedicated software. The PHY layer may be implemented using dedicated hardware or through software emulation.

As illustrated in FIG. 1, wireless network 100 comprises transmitting station (STA) 102, such as, for example, a wireless access point (AP), and one or more of a plurality of receiving STAs (STAs) 104. Transmitting STA 102 may provide for communication to associated receiving STAs 104 and may allow associated receiving STAs 104 to communicate with one or more external networks, such as the Internet.

As noted previously, in some embodiments, transmitting STA 102 may be a wireless access point (AP), such as a Wireless Fidelity (WiFi), Worldwide Interoperability for Microwave Access (WiMax), or broadband communication station, although the scope of the invention is not limited in this respect as transmitting STA 102 may be almost any communication station. In some embodiments, receiving STAs 104 may be communication stations (STAs) or mobile STAs such as WiFi, WiMax, or broadband communication stations, although the scope of the invention is not limited in this respect. The transmitting STA 102 and receiving STAs 104 are designated herein in the context of DL MU MIMO operations, however it is understood that each transmitting STA 102 and each receiving STA 104 is configured with receiving means and transmitting means for transmission and reception of signals in the wireless network 100.

In accordance with some embodiments, transmitting STA 102 employs a multi-user downlink having respective ACs with more than one of associated receiving STAs 104. In these embodiments, latency may be reduced for applications operating on selected associated receiving STAs 104. The applications may include time-sensitive applications, such as voice over IP (VoIP) or streamed video applications, which may have time-sensitive packet transmission requirements. In some embodiments, the applications may include applications having quality-of-service (QOS) level requirements. Quality-of-service level requirements may include data rate requirements, error rate requirements and/or packet priority requirements. In some embodiments, the quality-of-service level requirements may be based on the information content of the communications. The applications may also include less time-sensitive applications such applications that communicate best-effort traffic as well as background traffic. Although some embodiments are described reducing latency for time-sensitive applications, the scope of the invention is not limited in this respect, as some embodiments are equally applicable to almost any communication application operating on a transmitting STA 102. In some embodiments, time-sensitive applications may refer to any communication application having a packet-latency requirement.

In some embodiments, power consumption of associated communications stations may also be reduced. In some embodiments, transmitting STA 102 may substantially simultaneously or concurrently transmit downlink data through two or more receive antennas to two or more associated receiving STAs 104 on the same frequency subcarriers of a multicarrier communication channel. In these embodiments, transmitting STA 102 may internally separate the downlink data transmitted to the two or more associated receiving STAs 104 based on channel estimates for each associated receiving STA. In some embodiments, transmitting STA 102 may take advantage of the antenna diversity resulting from differently located associated receiving STAs.

In accordance with some embodiments, receiving STAs 104 may receive long and short frequency-interleaved orthogonal training signals that are to be concurrently transmitted from transmitting STA 102. The training signals are received through antennas 105 of receiving STAs 104. Receiving STA's 104 generate channel estimates and carrier frequency offset (CFO) estimates for the received training signals by performing an iterative decoding process using previously generated channel estimates and previously generated CFO estimates to cancel intercarrier interference (ICI) from the received training signals present due to loss of orthogonality induced by carrier frequency offsets.

In some embodiments, transmitting station 102 may transmit and/or receive OFDM or OFDMA communication signals over a multicarrier communication channel. These multicarrier communication signals may be within a predetermined frequency spectrum and may comprise a plurality of orthogonal subcarriers. In some embodiments, the orthogonal subcarriers may be closely-spaced subcarriers. To help achieve orthogonality between the closely-spaced subcarriers, each subcarrier may have a null at substantially a center frequency of the other subcarriers. In some embodiments, to help achieve orthogonality between the closely-spaced subcarriers, each subcarrier may have an integer number of cycles within a symbol period, although the scope of embodiments is not limited in this respect.

In some embodiments, the frequency spectrums for the multicarrier communication signals communicated between transmitting STA 102 (FIG. 1) and associated receiving STAs 104 (FIG. 1) may comprise either a 5 GHz frequency spectrum or a 2.4 GHz frequency spectrum. In these embodiments, the 5 GHz frequency spectrum may include frequencies ranging from approximately 4.9 to 5.9 GHz, and the 2.4 GHz spectrum may include frequencies ranging from approximately 2.3 to 2.5 GHz, although the scope of embodiments is not limited in this respect, as other frequency spectrums are also equally suitable. In some broadband and WiMax embodiments, the frequency spectrum for communications may comprise frequencies between 2 and 11 GHz, although the scope of embodiments is not limited in this respect.

The transmitting STA 102 and a number of the receiving STAs 104 may operate in the wireless network 100 using DL MU MIMO techniques.

In a DL MU MIMO operation, a transmitting STA, such as transmitting STA 102, transmits data destined for multiple receiving STAs, such as receiving STA's 104, simultaneously. In a MU TXOP, the transmitting STA may transmit packets that have different ACs assigned to them when they are pending for transmission. The term “access category” is used in wireless networks supporting the IEEE 802.11 Quality of Service standard, and is a label for the common set of enhanced distributed channel access (EDCA) parameters that are used by the quality of service (QoS) STA to contend for a channel. Four exemplary AC's may include: Voice (AC_VO), Video (AC_VI), Best Effort (AC_BE), and Background (AC_BK).

In a MU TXOP, since more than one AC may be involved in a DL MU MIMO transmission, current EDCA rules, which were destined for single user TXOP, may not be applicable. In particular, in a current implementation of an 802.11 BSS, a transmitting STA may push pending packets into first-in first-out (FIFO) queues in a sequential manner. The first packet in each AC queue may participate in an internal contention (that is, contention with other pending packets from the same STA). The winning packet from the internal contention may then participate in external contention with pending packets from other transmitting STA's, such as other transmitting STA's from the same network, or even with other transmitting STAs from competing networks. However, where a MU TXOP is involved, not only does the transmitting STA transmit the packet associated with the winning AC, the transmitting STA can choose packets associated with other AC's especially if those packets are destined for different STAs. EDCA rules applicable to a single user TXOP would not apply in such a case, since current EDCA rules merely advance packets sequentially without taking MU MIMO into consideration.

According to embodiments, a method of downlink multi-user multiple input multiple output (DL MU MIMO) communication using a transmitting station (STA) includes transmitting a plurality of aggregated MAC protocol data units (A-MDPUs) from the transmitting STA to respective ones a plurality of receiving STAs, the A-MDPUs being associated with respective access categories (ACs) and defining a primary AC. The method further includes doubling a contention window (CW) of at least one of the primary AC and a failed AC if an A-MPDU transmission failure occurs. As referred to herein, “failed AC” is an AC for which there has been a transmission failure, and a “failed receiving STA” or “failed STA” is a receiving STA for which there has been a transmission failure. According to some embodiments, doubling includes assigning a counter value to at least one of an AC and a STA, the counter value corresponding to zero or more instances a transmission failures for the at least one of the AC and the STA, assigning including incrementing the counter value for each of the transmission failures. Thus, when a transmission has been successful, there is zero instance of a transmission failure, and the counter value may be set to zero. For one instance of transmission failure, the counter value may be set to one. The counter value may be incremented for each subsequent instance of a transmission failure, and reset to zero one a transmission success takes place. The method further determining a contention window (CW) as a function of the counter value. After a contention window value is determined, a STA may calculate the value of backoff time slots by randomly choosing an integer from a uniform distribution of [0, CW] according to guidelines set forth in IEEE 802.11 set of standards. Examples of embodiments are described with respect to FIGS. 3-6 below.

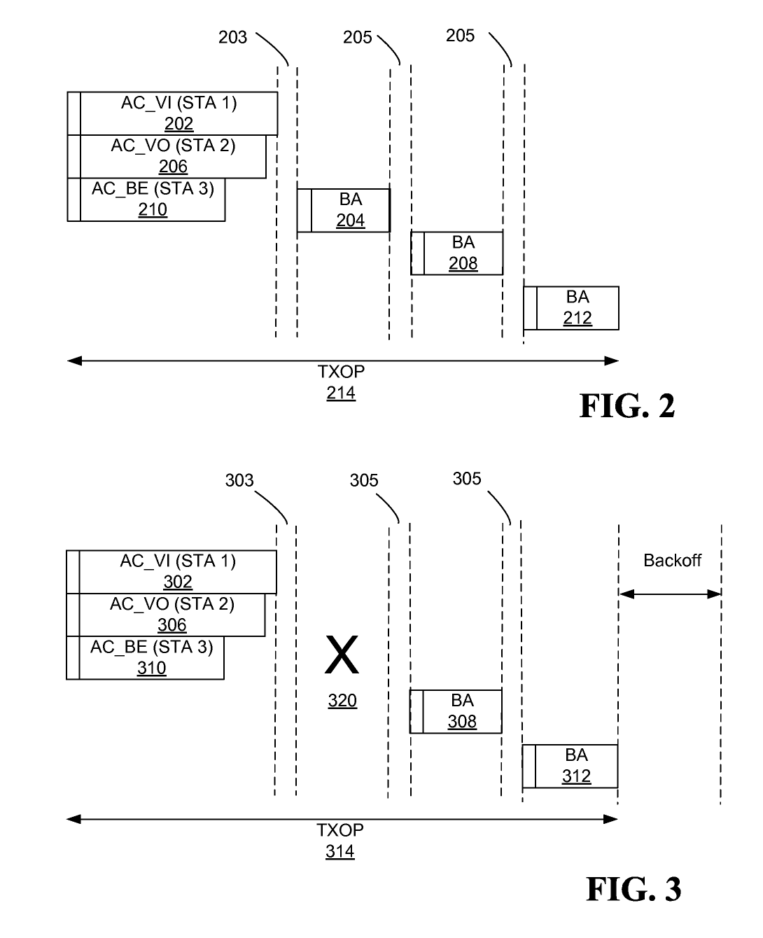

FIG. 2 is a block diagram of a DL MU MIMO operation in accordance with some embodiments. Three receiving STAs and one transmitting STA are used in this embodiment; however additional receiving STAs and/or transmitting STAs may also be present in the wireless network 100. The receiving STAs and transmitting STA may be similar to the ones described in relation to FIG. 1. The transmitting STA and the number of receiving STAs form a basic service set (BSS) known to one skilled in the art, wherein the stations contend to transmit data frames or packets. The transmitting STA in the BSS may be configured for DL MU MIMO communication.

According to the example of the shown MU TXOP block diagram, the transmitting STA or AP sends aggregated MAC protocol data units (A-MPDUs) to three receiving STAs, namely, in the shown embodiment, STA1, STA2 and STA3. The individual MDPU's include a STA1 data frame 202 associated with AC_VI, a STA2 data frame 206 associated with AC_VO, and a STA3 data frame 210 associated with AC_BE. Each of STA1, STA2 and STA3 may then send respective response frames or block acknowledgments (BAs) 204, 208 and 212 back to the transmitting STA. The STA1 data frame 202 AC_VI corresponds to the primary AC, that is, to the AC that wins the internal contention. The MU data frames schedule the transmission time for each STA to transmit back a response frame. The STA that is the first to respond is the primary STA. A short interframe space 203 follows the data frames 202, 206 and 210 while SIFS or Reduced inter-frame space (RIFS) 205 follows the block acknowledgements 204 and 208. The time from the beginning of the primary AC data frame 201 to the end of BA 212 corresponds to the TXOP 214 of the transmitting STA. As suggested in FIG. 2, the transmitting STA piggy backs the data frames 206 and 210 destined for STAs other than the STA associated with the primary AC, that is, other than STA1 in the shown example, onto the same DL MU MIMO transmission, that is, onto the primary AC data frame. As seen in FIG. 2, the packets destined for other STAs can be associated with different ACs or with the same AC. In the case of DL MU MIMO, a transmitting STA may receive block acknowledgment frames from some but not all destination or receiving STAs. Thus, when a packet destined for a given STA is not successfully received by that STA, there would be no BA from that STA coming back to the transmitting STA. Embodiments provide various ways in which to take error handling for DL MU MIMO into consideration to ensure improved transmissions as described below.

According to a first embodiment, an example of which is provided in FIG. 3, the transmitting STA may only keep track of the primary AC. Should a transmission failure occur for the primary AC, the transmitting STA may then increment the contention window (CW) for the primary AC, from which the backoff window may be determined, and the primary AC may then enter exponential backoff. In such a case, according to one embodiment, the CW for the primary AC would be given by Equations (1a) and (1b) below:

CW[primary AC]=2*(CW[primary AC]+1)−1 Eq.(1a)
if CW[primary_AC]<CWmax[primary_AC]
   and

CW[primary AC]=CW[primary AC], Eq. (1b)
if CW[primary AC]=CWmax[primary AC]
   The random backoff time slot corresponding to the primary AC may be randomly chosen from a uniform distribution of [0, CW[primary_AC] as dicated by the IEEE 802.11 set of standards, and the primary AC may then enter exponential backoff. However, if the transmission of the primary AC to the primary STA is a success, the transmitting STA may initiate a successful backoff where the CW[primary_AC] is given by Equation (2) as noted below:

CW[primary AC]=CWmin[primary AC] Eq. (2)

Thus, referring still to FIG. 3, according to the example of the shown MU TXOP block diagram, the transmitting STA or AP sends a MAC protocol data unit (MPDUs) or A-MPDUs to three receiving STAs, namely, in the shown embodiment, STA1, STA2 and STA3, similar to arrangement referred to above with respect to FIG. 2. The individual MDPU's include a STA1 data frame 302 associated with primary AC_VI, a STA2 data frame 306 associated with AC_VO, and a STA3 data frame 310 associated with AC_BE. In the shown example, STA1 data frame 302 corresponds to the primary AC. Each of STA2 and STA3 send respective response frames or block acknowledgments (BAs) 310 and 312 back to the transmitting STA. FIG. 3 shows a transmission failure however occurring for the primary AC, which in the example of FIG. 3 happens to be AC_VI (STA1), as shown by the X noted in the time interval 320 following SIFS 303. SIFS 303 corresponds to the interframe space that follows the data frames 302, 306 and 310, while additional SIFS' 305 follow the block acknowledgements 308 and the time interval 320 that would have been associated with the BA from STA1 but for the failure. The time from the beginning of the primary AC data frame 302 to the end of BA 312 corresponds to the TXOP 314 of the transmitting STA. In the shown embodiment, according to the example of FIG. 3, the transmitting STA may increment CW[AC_VI], that is, the primary AC contention window, to an exponential value. In such a case, according to one embodiment, CW[AC-VI] would be given by Equation (3) based on Equation (1) as:

CW[AC_{—}VI]=2*(CW[AC_{—}VI]+1)−1 Eq. (3)

If the transmission to the primary STA is a success, the transmitting STA may initiate a successful backoff where the CW is given by Equation (2). In the above embodiment, the contention windows associated with the secondary AC's, in the shown example of FIG. 3, AC_VO and AC_BE, would not be changed and the secondary AC's could resume their backoff countdowns using the original counter values. The first embodiment, as described with respect to the example of FIG. 3, is based on a higher likelihood that a primary AC will have collisions, and hence does away with addressing error handling for the secondary AC's, and also combines the internal and external contentions, that is, a. primary AC would win the internal contention and external contention at the same time. This first embodiment is apt to consume less memory and be implemented using current architecture.

According to a second embodiment, referring still to FIG. 3, the transmitting STA may keep a counter for every receiving AC. Should a transmission failure occur for a given AC, the transmitting STA may then increment a counter for that AC such that the backoff time period may corresponds to an exponential backoff using the CWmin of that AC. In such a case, according to one embodiment, the CW for the failed AC would be given by Equation (4) below:

CW[ACₙ]=2̂counter[ACₙ]*CWmin[ACₙ] Eq. (4)

where ACₙ corresponds to the AC corresponding to a STA from which a BA was not received. However, should a transmission for an AC be successful, the transmitting STA resets the counter for that AC back to zero. Thus, for each packet at the head of queue, the transmitting STA may check the counter associated with a given AC. If the counter is non-zero, the transmitting STA may initiate an exponential backoff period using CW given by Equation (4). However, if the counter is zero, the transmitting STA may initiate a successful backoff where the CW is CWmin[ACₙ]. Under the second embodiment, according to the example of FIG. 3, the transmitting STA may increment CW[AC_VI], that is, the failed AC contention window, to an exponential value. In such a case, according to one embodiment, CW[AC-VI] would be given by Equation (5) as:

CW[AC_{—}VI]=2̂counter[AC_{—}VI]*CWmin[AC_{—}VI] Eq. (5)

The second embodiment, as described with respect to the example of FIG. 3, allows a more conservative assessment of the possibility of collisions by using collision information with respect to specific AC's. The second embodiment, for the above reasons, may require further memory than the first embodiment.

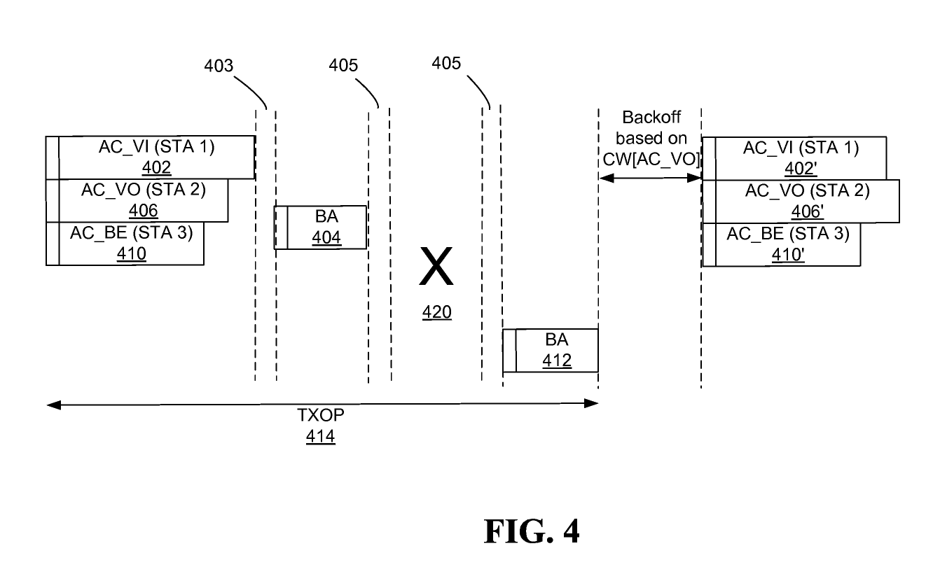

According to a third embodiment, an example of which is provided in FIG. 4, the transmitting STA may keep a counter for every receiving STA, which are all the STAs associated with the AP in the same basic service set (BSS). Should a transmission failure occur for a given STA, the AP may then increment a counter for that STA such that the backoff time period corresponds to an exponential backoff using the CWmin of the AC associated with the failed packet. In such a case, according to one embodiment, the CW for the would be given by Equation (6) below:

CW[AC(STAₙ)]=2̂counter[STAₙ]*CWmin[AC(STAₙ)]Eq. (6)

where STAₙ corresponds to the STA from which a BA was not received, and AC(STAₙ) corresponds to the failed AC. However, should a transmission for a STA be successful, the transmitting STA resets the counter for that STA back to zero. Thus, for each packet at the head of queue, the transmitting STA may check the counter associated with a given STA. If the counter is non-zero, the transmitting STA may initiate an exponential backoff period using CW given by Equation (6). However, if the counter is zero, the transmitting STA may initiate a successful backoff where the CW is given by CWmin[ACₙ].

According to a fourth embodiment, an example of which is still provided in FIG. 4, the transmitting STA may keep a counter for every receiving STA per AC. Should a transmission failure occur for a given STA and the particular AC associated with that STA, the transmitting STA may then increment a counter for that STA/AC combination such that the backoff time period corresponds to an exponential backoff using the CWmin of the AC in the STA/AC combination. In such a case, according to one embodiment, the CW for the failed AC would be given by Equation (8) below:

CW[AC(STAₙ)]=2̂counter[STAₙ/AC]*CWmin[AC(STAₙ)] Eq. (8)

Where STAₙ corresponds to the STA from which a BA was not received, STAₙ/AC corresponds to the STA/AC combination for which no BA was received, and AC(STAₙ) corresponds to the AC associated with STAₙ. However, should a transmission for a STA be successful, the transmitting STA resets the counter for that STA and for its associated AC back to zero. Thus, for each packet at the head of queue, the transmitting STA may check the counter associated with a given STA and its associated AC. If the counter is non-zero, the transmitting STA may initiate an exponential backoff period using CW given by Equation (8). However, if the counter is zero, the transmitting STA may initiate a successful backoff where the CW is given by CWmin[AC(STAₙ)].

Thus, referring still to FIG. 4, according to the example of the shown MU TXOP block diagram, the transmitting STA or AP sends aggregated MAC protocol data units (A-MPDUs) to three receiving STAs, namely, in the shown embodiment, STA1, STA2 and STA3, similar to arrangement referred to above with respect to FIG. 2. The individual MDPU's include a STA1 data frame 402 associated with primary AC_VI, a STA2 data frame 406 associated with AC_VO, and a STA3 data frame 410 associated with AC_BE. Each of STA1 and STA3 sends respective response frames or block acknowledgments (BAs) 404 and 412 back to the transmitting STA. FIG. 4 shows a transmission failure however occurring for the AC_VO and STA2, as shown by the X noted in the time interval following the first SIFS 405. SIFS 403 is the interframe space that follows the data frames 402, 406 and 410, while additional SIFS' 405 follow the block acknowledgement 404 and the time interval 420 that would have been associated with the BA from STA2 but for the failure. The time from the beginning of the primary AC data frame 402 to the end of BA 412 corresponds to the TXOP 414 of the transmitting STA. Under the shown embodiment, according to the example of FIG. 4, the transmitting STA may increment CW[AC_VO], that is, the failing AC contention window, to an exponential value.

In such a case, referring to the example of FIG. 4, according to the third embodiment, CW[AC-VO] would be given by Eq. (7) based on Equation (6) as:

CW[AC_{—}VO]=2̂counter[STA2]*CWmin[AC_VO] Eq. (7)

However, under the fourth embodiment, referring still to the example of FIG. 4, the transmitting STA may increment CW[AC_VO(STA2)] to an exponential value. In such a case, according to one embodiment, CW[AC-VO(STA2)] would be given by Equation (8) as:

CW[AC_{—}VO]=2̂counter[STA2/AC_{—}VO]*CWmin[AC_{—}VO] Eq. (8)

Referring still to FIG. 4, a STA1 data frame 402′ associated with AC_VI, a STA2 data frame 406′ associated with AC_VO (the primary AC here), and a STA3 data frame 410′ associated with AC-BE are shown as following the failed set of A-MPDU's 402, 406 and 410. To the extent that, in FIG. 4, data frame 406′ associated with AC_VO corresponds to the data frame of the primary AC, the CW preceding data frames 402′, 406′ and 410′ corresponds in the shown example to CW[AC_VO] calculated according to either of Equations (7) and (8) above. If the primary AC in data frames 402′, 406′ and 410′ were not AC_VO, the backoff time period would not necessarily be based on CW[AC_VO] as calculated above.

The third embodiment, as described with respect to the example of FIG. 4, allows a more conservative assessment of the possibility of collisions by basing a calculation of the CW on collision information with respect to specific receiving STAs. The third embodiment, for the above reasons, may require further memory than the first embodiment.

The fourth embodiment, as described with respect to the example of FIG. 4, allows an even more conservative assessment of the possibility of collisions than the previous embodiments by basing an assessment of CW on information regarding failures on counter values for each STA/AC combination. This higher degree of granularity is provided in part by the fact that the fourth embodiment does not limit the calculation of the CW to taking the CWmin of only the primary AC into consideration, does not limit the calculation of the CW on only a STA counter value information, but takes into consideration every STA/AC combination for which a failure may have occurred. Implementation of this fourth embodiment may therefore require further memory as compared with the first and second embodiments.

In embodiments where a counter value is proposed, whether a counter is associated with an AC or with a STA or both, the counter may be reset to zero when a packet from that AC, from that STA or from that STA/AC combination is dropped after reaching its retry limit.

In addition, the third and fourth embodiments may accommodate a situation where packet transmission failures would occur for more than one STA, or for more than one STA/AC combination in a single transmission. In such a case, the contention windows for each failing STA, or for each failing STA/AC combination, may be incremented as noted with respect to Equations (6) and (8).

It is further to be noted that calculation of the CW for a given AC does not necessarily mean that the backoff time period will be based on the thus calculated CW. As would be recognized by the skilled person, the CW of a primary AC for the next set of A-MPDUs may control the backoff time period prior to that next set of A-MPDUs.

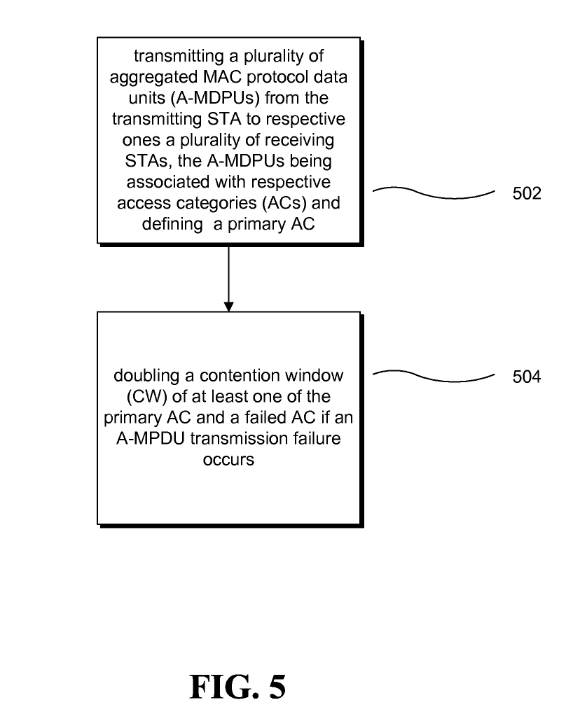

FIG. 5 is a flow diagram depicting a method embodiment. At block 502, the method includes transmitting a plurality of aggregated MAC protocol data units (A-MDPUs) from the transmitting STA to respective ones a plurality of receiving STAs, the A-MDPUs being associated with respective access categories (ACs) and defining a primary AC. The method further includes at block 504 doubling a contention window (CW) of at least one of the primary AC and a failed AC if an A-MPDU transmission failure occurs.

Embodiments may be described herein with reference to data such as instructions, functions, procedures, data structures, application programs, configuration settings, etc. For purposes of this disclosure, the term “program” covers a broad range of software components and constructs, including applications, drivers, processes, routines, methods, modules, and subprograms. The term “program” can be used to refer to a complete compilation unit (i.e., a set of instructions that can be compiled independently), a collection of compilation units, or a portion of a compilation unit. Thus, the term “program” may be used to refer to any collection of instructions which, when executed by the receiving station 102 or the receiving STA 104, provides UL MU MIMO communication.

The operation discussed herein may be generally facilitated via execution of appropriate firmware or software embodied as code instructions on tangible media as applicable. Thus, embodiments may include sets of instructions executed on some form of processing core or otherwise implemented or realized upon or within a machine-readable medium. A machine-readable medium includes any mechanism for storing or transmitting information in a form readable by a machine (e.g., a computer). For example, a machine-readable medium can include an article of manufacture such as a read only memory (ROM); a random access memory (RAM); a magnetic disk storage media; an optical storage media; and a flash memory device, etc. In addition, a machine-readable medium may include propagated signals such as electrical, optical, acoustical or other form of propagated signals (e.g., carrier waves, infrared signals, digital signals, etc.).

While certain features of embodiments have been illustrated and described herein, many modifications, substitutions, changes, and equivalents will now occur to those skilled in the art. It is, therefore, to be understood that the appended claims are intended to cover all such modifications and changes.

What is claimed is:

1. A method of downlink multi-user multiple input multiple output (DL MU MIMO) communication using a transmitting station (STA), comprising:
transmitting a plurality of aggregated MAC protocol data units (A-MDPUs) from the transmitting STA to respective ones a plurality of receiving STAs, the A-MDPUs being associated with respective access categories (ACs) and defining a primary AC;
doubling a contention window (CW) of at least one of the primary AC and a failed AC if an A-MPDU transmission failure occurs.

2. The method of claim 1, wherein doubling includes doubling the CW of the primary AC according to the following equation:
CW[primary AC]=2*(CW[primary AC]+1)−1
if CW[primary_AC]<CWmax[primary_AC], where CW[primary_AC] is the CW of the primary AC, and CWmax[primary_AC] is a maximum CW of the primary AC.

3. The method of claim 1, further comprising setting the CW to be equal to CWmin of at least one of the primary AC and the failed AC when the counter value is zero.

4. The method of claim 1, wherein doubling includes:
assigning a counter value to at least one of an AC of the respective ACs and a receiving STA of the receiving STAs, the counter value corresponding to zero or more instances of transmission failures for the AC and the receiving STA, assigning including incrementing the counter value for each of the transmission failures; and
determining the contention window (CW) as a function of the counter value.

5. The method of claim 4, wherein assigning includes assigning a counter value to each of the ACs.

6. The method of claim 5, wherein determining includes increasing the CW according to the following equation:
CW[ACₙ]=2̂counter[ACₙ]*CWmin[ACₙ]
where ACₙ is the failed AC, counter[ACₙ] is the counter value for ACₙ, and CWmin[ACₙ] is a CWmin for ACₙ.

7. The method of claim 4, wherein assigning includes assigning the counter value to each of the receiving STAs.

8. The method of claim 7, wherein determining includes increasing the CW according to the following equation:
CW[AC(STAₙ)]=2̂counter[STAₙ]*CWmin[AC(STAₙ)]
where STAₙ is a failed receiving STA, counter[STAₙ] is the counter value assigned to STAₙ, and CWmin[AC(STAₙ)] is a CWmin of the AC associated with STAₙ.

9. The method of claim 4, wherein assigning includes assigning the counter value to each of the receiving STAs per each of the AC's.

10. The method of claim 9, wherein determining includes increasing the CW according to the following equation:
CW[AC(STAₙ)]=2̂counter[STAₙ/AC]*CWmin[AC(STAₙ)]
where counter[STAₙ/AC] is the counter value assigned to a receiving STA and AC combination for which a transmission failure has occurred, STAₙ is a failed receiving STA, and CWmin[AC(STAₙ)] is a CWmin of an AC associated with STAₙ.

11. A station (STA), comprising:
a media access controller (MAC) to receive data and to generate a MAC protocol data unit (MPDU);
a physical layer (PHY) to receive the MPDU and to generate a preamble and a PHY header;
a transceiver array configured to:
transmit a plurality of aggregated MAC protocol data units (A-MDPUs) from the transmitting STA to respective ones a plurality of receiving STAs, the A-MDPUs being associated with respective access categories (ACs) and defining a primary AC;
double a contention window (CW) of at least one of the primary AC and a failed AC if an A-MPDU transmission failure occurs.

12. The STA of claim 11, wherein the transceiver is to double by doubling the CW of the primary AC according to the following equation:
CW[primary AC]=2*(CW[primary AC]+1)−1
if CW[primary_AC]<CWmax[primary_AC], where CW[primary_AC] is the CW of the primary AC, and CWmax[primary_AC] is a maximum CW of the primary AC.

13. The STA of claim 11, wherein the transceiver is further to set the CW to be equal to CWmin of at least one of the primary AC and the failed AC if the counter value is zero.

14. The STA of claim 11, wherein the transceiver is to double by:
assigning a counter value to at least one of an AC of the respective ACs and a receiving STA of the receiving STAs, the counter value corresponding to zero or more instances of transmission failures for the AC and the receiving STA, assigning including incrementing the counter value for each of the transmission failures; and
determining the contention window (CW) as a function of the counter value.

15. The STA of claim 14, wherein assigning includes assigning a counter value to each of the ACs.

16. The STA of claim 15, wherein determining includes increasing the CW according to the following equation:
CW[ACₙ]=2̂counter[ACₙ]*CWmin[ACₙ]
where ACₙ is the failed AC, counter[ACₙ] is the counter value for ACₙ, and CWmin[ACₙ] is a CWmin for ACₙ.

17. The STA of claim 14, wherein assigning includes assigning the counter value to each of the receiving STAs.

18. The STA of claim 17, wherein determining includes increasing the CW according to the following equation:
CW[AC(STAₙ)]=2̂counter[STAₙ]*CWmin[AC(STAₙ)]
where STAₙ is a failed receiving STA, counter[STAₙ] is the counter value assigned to STAₙ, and CWmin[AC(STAₙ)] is a CWmin of the AC associated with STAₙ.

19. The STA of claim 14, wherein assigning includes assigning the counter value to each of the receiving STAs per each of the AC's.

20. The STA of claim 19, wherein determining includes increasing the CW according to the following equation:
CW[AC(STAₙ)]=2̂counter[STAₙ/AC]*CWmin[AC(STAₙ)]
where counter[STAₙ/AC] is the counter value assigned to a receiving STA and AC combination for which a transmission failure has occurred, STAₙ is a failed receiving STA, and CWmin[AC(STAₙ)] is a CWmin of an AC associated with STAₙ.

21. A computer readable medium encoded with computer executable instructions which, when accessed, cause a machine to perform operations comprising:
transmitting a plurality of aggregated MAC protocol data units (A-MDPUs) from the transmitting STA to respective ones a plurality of receiving STAs, the A-MDPUs being associated with respective access categories (ACs) and defining a primary AC; and
doubling a contention window (CW) of at least one of the primary AC and a failed AC if an A-MPDU transmission failure occurs.

22. The computer readable medium of claim 21, wherein doubling includes doubling the CW of the primary AC according to the following equation:
CW[primary AC]=2*(CW[primary AC]+1)−1
if CW[primary_AC]<CWmax[primary_AC], where CW[primary_AC] is the CW of the primary AC, and CWmax[primary_AC] is a maximum CW of the primary AC.

23. The computer readable medium of claim 21, further comprising setting the CW to be equal to CWmin of at least one of the primary AC and the failed AC if the counter value is zero.

24. The computer readable medium of claim 21, wherein doubling includes:
assigning a counter value to at least one of an AC of the respective ACs and a receiving STA of the receiving STAs, the counter value corresponding to zero or more instances of transmission failures for the AC and the receiving STA, assigning including incrementing the counter value for each of the transmission failures; and
determining the contention window (CW) as a function of the counter value.

25. The computer readable medium of claim 24, wherein assigning includes assigning a counter value to each of the ACs.

26. The computer readable medium of claim 25, wherein determining includes increasing the CW according to the following equation:
CW[ACₙ]=2̂counter[ACₙ]*CWmin[ACₙ]
where ACₙ is the failed AC, counter[ACₙ] is the counter value for ACₙ, and CWmin[ACₙ] is a CWmin for ACₙ.

27. The computer readable medium of claim 24, wherein assigning includes assigning the counter value to each of the receiving STAs.

28. The computer readable medium of claim 27, wherein determining includes increasing the CW according to the following equation:
CW[AC(STAₙ)]=2̂counter[STAₙ]*CWmin[AC(STAₙ)]
where STAₙ is a failed receiving STA, counter[STAₙ] is the counter value assigned to STAₙ, and CWmin[AC(STAₙ)] is a CWmin of the AC associated with STAₙ.

29. The computer readable medium of claim 24, wherein assigning includes assigning the counter value to each of the receiving STAs per each of the AC's.

30. The computer readable medium of claim 29, wherein determining includes increasing the CW according to the following equation:
CW[AC(STAₙ)]=2̂counter[STAₙ/AC]*CWmin[AC(STAₙ)]
where counter[STAₙ/AC] is the counter value assigned to a receiving STA and AC combination for which a transmission failure has occurred, STAₙ is a failed receiving STA, and CWmin[AC(STAₙ)] is a CWmin of an AC associated with STAₙ.
